(19) United States
(12) Patent Application Publication
(10) Pub. No.: US 2014/0057141 A1
(43) Pub. Date: Feb. 27, 2014

(54) PRESSURE BALANCING OF ELECTROLYTES IN REDOX FLOW BATTERIES

(71) Applicant: EnerVault Corporation, Sunnyvale, CA (US)

(72) Inventors: Ron MOSSO, Fremont, CA (US); Sumitha DURAIRAJ, San Jose, CA (US); Jay SHA, Mountain View, CA (US); Jeremy MEYERS, Sunnyvale, CA (US)

(73) Assignee: EverVault Corporation, Sunnyvale, CA (US)

(21) Appl. No.: 13/975,044

(22) Filed: Aug. 23, 2013

Related U.S. Application Data
(60) Provisional application No. 61/692,347, filed on Aug. 23, 2012.

(51) Int. Cl. H01M 8/20

(52) U.S. Cl. CPC H01M 8/20
USPC 429/51; 429/101; 429/90; 429/63; 429/72

(57) ABSTRACT

Methods and apparatuses are disclosed for mitigating electrolyte migration in a redox flow battery system. A first parameter of a first electrolyte in a first flow path of a redox flow battery cell block may be measured. The first flow path may have an inlet to and an outlet from the redox flow battery cell block. A second parameter of a second electrolyte in a second flow path of the redox flow battery cell block may be measured. The second flow path may have an inlet to and an outlet from the redox flow battery cell block. The first parameter may be detected to be greater than the second parameter. A first device coupled to the redox flow battery cell block in the second flow path may be operated to increase the second parameter in the second flow path.

### RELATED APPLICATIONS

This application claims the benefit of priority to U.S. Provisional Patent Application No. 61/692,347, filed Aug. 23, 2012, the entire contents of which are incorporated herein by reference.

### STATEMENT OF FEDERALLY FUNDED RESEARCH

Inventions included in this patent application were made with Government support under DE-OE0000225 “Recovery Act—Flow Battery Solution For Smart Grid Renewable Energy Applications” awarded by the US Department of Energy (DOE). The Government has certain rights in these inventions.

### FIELD

This application generally relates to redox flow battery systems, and more particularly to systems and methods for balancing pressures and/or flow rates in separate electrolyte streams in redox flow battery systems.

### BACKGROUND

Flow batteries are electrochemical energy storage systems in which electrochemical reactants are dissolved in liquid electrolytes (sometimes referred to generically as “reactants”), which are pumped through reaction cells where electrical energy is either converted to or extracted from chemical potential energy in the reactants by way of reduction and oxidation reactions. In applications where megawatts of electrical energy must be stored and discharged, a redox flow battery system can be expanded to the required energy storage capacity by increasing tank sizes and expanded to produce the required output power by increasing the number or size of electrochemical cells or cell blocks. A variety of flow battery chemistries and arrangements are known in the art.

For example, some redox flow battery systems are based on the Fe/Cr redox couple, in which the catholyte (in the positive half-cell) contains FeCl₃, FeCl₂ and HCl and the anolyte (in the negative half-cell) contains CrCl₃, CrCl₂ and HCl. Such a system is known as an “un-mixed reactant” system. In a “mixed reactant” system, the anolyte also contains FeCl₂, and the catholyte also contains CrCl₃. In an initial state of either case, the catholyte and anolyte typically have equimolar reactant concentrations.

Side reactions occurring during a charge and/or discharge operations can cause electrolyte concentrations to become un-balanced, and can cause other problems. For example, in the case of an Fe/Cl redox flow battery, a hydrogen generation side-reaction occurs at the anode during the charge cycle. Such side reactions cause an imbalance in electrolyte concentrations by converting more reactant in one half-cell to a higher state of charge than occurs in the second electrolyte. In this unbalanced state, for example, the concentration of Fe³⁺ can be higher than that of Cr²⁺. The imbalance decreases capacity of the battery and is undesirable. The proportion of hydrogen gas generated, and thus the degree of reactant imbalance, also increases as the state-of-charge (SOC) increases.

### SUMMARY OF THE INVENTION

Thus, in various aspects, an embodiment method may be provided of mitigating electrolyte migration in a redox flow battery system. An embodiment method may include measuring a first pressure of a first electrolyte in a first flow path of a redox flow battery cell block. The first flow path may have an inlet to and an outlet from the redox flow battery cell block. An embodiment method may further include measuring a second pressure of a second electrolyte in a second flow path of the redox flow battery cell block. The second flow path may have an inlet to and an outlet from the redox flow battery cell block. An embodiment method may further include detecting that the first pressure is greater than the second pressure, and operating a first device coupled to the redox flow battery cell block in the second flow path to increase the second pressure in the second flow path. An embodiment method may further include operating a second device coupled to the redox flow battery cell block in the first flow path to decrease the first pressure in the first flow path. In an embodiment method the first device may be a flow control device coupled to the outlet of the second flow path, and operating the device coupled to the redox flow battery cell block in the second flow path may comprise operating the flow control device so as to restrict an outlet flow of the second electrolyte in the second flow path and thereby increase the second pressure.

In a further embodiment method, the first device may be a flow control device coupled to the inlet of the second flow path, and operating the device coupled to the redox flow battery cell block in the second flow path may comprise operating the flow control device so as to open an inlet flow of the second electrolyte in the second flow path and thereby increase the second pressure. In an embodiment method, the second device may be a flow control device coupled to the outlet of the second flow path, and operating the second device coupled to the redox flow battery cell block in the first flow path may comprise operating the flow control device so as to open an outlet flow of the first electrolyte in the first flow path and thereby decrease the first pressure. In an embodiment method, the second device may be a flow control device coupled to the inlet of the second flow path, and operating the second device coupled to the redox flow battery cell block in the first flow path may comprise operating the flow control device so as to restrict an inlet flow of the first electrolyte in the first flow path and thereby decrease the first pressure. Further in embodiment methods, the first device may be positioned at the outlet of the second flow path. In an embodiment method, the first device may be positioned at the inlet of the second flow path. Further in embodiment methods, the first device may comprise a flow control valve. In embodiment methods, the first device may comprise a flow control pump. In embodiment methods, the first device may comprise a passive flow restrictor. Further in embodiment methods, the flow control pump may be selected from the group consisting of: a gear pump, a screw pump, a paddle pump, a peristaltic pump, a progressive cavity pump, a piston pump, a diaphragm pump, a positive displacement flow meter, and a nutating disk flow meter.

In a further embodiment method, operating a first device coupled to the redox flow battery cell block in the second flow path to increase the second pressure in the second flow path may comprise operating the flow control pump to increase a pumped flow rate of the second electrolyte in the second flow path. In embodiment methods, the flow control device may comprise a flow resistor. Further in embodiment methods, detecting that the first pressure is greater than the second pressure may comprise detecting one of the first pressure or the second pressure at a corresponding one of the outlet of the first flow path or the outlet of the second flow path. In embodiment methods, the flow control pump may include a flow meter at an outlet of the second flow path. In embodiment methods, the second electrolyte in the second flow path may include a catholyte of the redox flow battery cell block. In embodiment methods, the redox flow battery cell block may comprise a final cell block in a plurality of cell blocks arranged in a cascade configuration along the first and the second flow paths, the redox flow battery cell block positioned adjacent to an outlet end of the cascade. In embodiment methods, operating a first device coupled to the redox flow battery cell block in the second flow path to increase the second pressure in the second flow path may comprise operating the first device to provide a shunt resistance to a shunt current flowing in the second electrolyte in the second flow path. In embodiment methods, the first device may include a shunt resistor.

In embodiments, an apparatus may be provided for mitigating electrolyte migration in a redox flow battery system. In embodiments, a first block of electrochemical cells and a second block of electrochemical cells may be arranged along a first flow channel carrying a first electrolyte and a second flow channel carrying a second electrolyte. In embodiments, the first block and the second block may be arranged along the first and the second flow channels such that the first electrolyte and the second electrolyte flow out of the first block and into the second block. Further in embodiments, a first device may be positioned at an inlet side of the first block. The first device may be coupled to one or more of the first flow channel and the second flow channel. Further in embodiments, a second device may be positioned at an outlet side of the second block. The second device may be coupled to one or more of the first flow channel and the second flow channel. Further in embodiments, a controller may be coupled to the first device and the second device. The controller may be configured to control at least one of the first device and the second device to balance a first control flow parameter in the first flow channel and a second flow control parameter in the second flow channel. In embodiments, the first flow control parameter may be a first pressure and the second flow parameter may be a second pressure. Further in embodiments, the first flow control parameter may be a first flow rate and the second flow parameter may be a second flow rate. In embodiments, the second block may be positioned at an outlet end of a cascade of cell blocks. The second device may be coupled only to the outlet side of the second block. In embodiments, the first block and the second block may be positioned respectively at an inlet end and an outlet end of a cascade of cell blocks. The first device and the second device may be coupled only respectively to the inlet side of the first block and the outlet side of the second block. In embodiments, a third device may be positioned between the first block and the second block. The third device may be coupled to one or more of the first flow channel and the second flow channel. In embodiments, the second device may comprise a flow control device coupled to the second flow channel. In embodiments, at least one of the first device or the second device may be selected from the group consisting of: a valve, a ball valve, a gate valve, a globe valve, a diaphragm valve, a butterfly valve, a needle valve, a solenoid valve, an orifice check valve, a flow resistor, a pump, a gear pump, a screw pump, a paddle pump, a peristaltic pump, a progressive cavity pump, a piston pump, a diaphragm pump, a positive displacement flow meter and a nutating disk flow meter.

In further embodiments, a first pressure sensor may be coupled to the first flow channel and a second pressure sensor may be coupled to the second flow channel. The first pressure sensor and the second pressure sensor coupled to the controller. The first pressure sensor and the second pressure sensor may be configured to provide first and second pressure signals to the controller corresponding to the first pressure and the second pressure. In embodiments, at least one of the first pressure sensor and the second pressure sensor may be positioned at the outlet side of the second block. Further in embodiments, the controller may be further configured to determine a pressure difference between the first pressure and the second pressure based on the first pressure signal and the second pressure signal and may control the operation of at least one of the first device and the second device to balance the pressure. Further in embodiments, the controller may be configured to determine that the first pressure is greater than the second pressure based on the first pressure signal and the second pressure signal, and may control the operation of the second device to increase the second pressure in the second flow channel. In embodiments, a first flow rate sensor may be coupled to the first flow channel and a second flow rate sensor may be coupled to the second flow channel. The first flow rate sensor and the second flow rate sensor may be coupled to the controller. The first flow rate sensor and the second flow rate sensor may be configured to provide first and second flow rate signals to the controller corresponding to the first flow rate and the second flow rate. In embodiments, at least one of the first flow rate sensor and the second flow rate sensor may be positioned at the outlet side of the second block.

Further in embodiments, the controller may be configured to determine a flow rate difference between the first flow rate and the second flow rate based on the first flow rate signal and the second flow rate signal and may control the operation of at least one of the first device and the second device to balance the flow rates. In embodiments, the controller may be configured to determine that the first flow rate is greater than the second flow rate based on the first flow rate signal and the second flow rate signal, and may control the operation of the first device to decrease the first flow rate in the first flow channel. In embodiments, the first device and the second device may include a flow control device. In embodiments, the first device and the second device may further include shunt resistor devices. Further in embodiments, the flow control device may include a pump selected from the group consisting of: a gear pump, a screw pump, a paddle pump, a peristaltic pump, a progressive cavity pump, a piston pump, a diaphragm pump, a positive displacement flow meter, and a nutating disk flow meter. In embodiments, the flow control device may comprise an electromechanically actuated valve.

In further embodiments, a redox flow battery system may be provided. In embodiments, a first block of electrochemical cells and a second block of electrochemical cells may be arranged along a first flow channel carrying a first electrolyte and a second flow channel carrying a second electrolyte. The first block and the second block may be arranged along the first and the second flow channels such that the first electrolyte and the second electrolyte may flow out of the first block and into the second block. In embodiments, a first device may be positioned in the first flow channel at an inlet side of the first block. The first device may be configured to allow unrestricted flow in a first direction and restricted flow in an opposite second direction. In embodiments, a second device may be positioned in the first flow channel at an outlet side of the second block. The first device may be configured to allow unrestricted flow in the second direction and restricted flow in the first direction. Further in embodiments, the first device and the second device may comprise orifice check valves.

### BRIEF DESCRIPTION OF DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a schematic diagram illustrating a redox flow battery system configured for balancing electrolyte pressures and flow rates.

FIG. 2 is a schematic diagram illustrating an example redox flow battery system having a flow control system in combination with a cascade of electrochemical cell blocks arranged in fluidic series with flow control devices positioned at inlet and outlet ends of the cascade in embodiments.

FIG. 3 is a schematic diagram illustrating an example redox flow battery system having a flow control system in combination with a cascade of electrochemical cell blocks arranged in fluidic series with flow control devices interleaved between adjacent cell blocks in embodiments.

FIG. 4 is a diagram illustrating a partially-transparent perspective view of a shunt resistor configured to provide a variable resistance to fluid flow through in embodiments.

FIG. 5 is a schematic illustration of a flow battery cell block with pressure/flow sensors and flow control devices in each electrolyte flow line.

FIG. 6 is a process flow diagram illustrating an embodiment method of a control algorithm for balancing pressures and/or flow rates in two flowing electrolyte streams in a redox flow battery system.

FIG. 7 is a diagram illustrating a cross-sectional view of a passive pressure sensing device in embodiments.

FIG. 8 is a schematic diagram illustrating a passive pressure balancing device configured to balance pressures in two flow channels in embodiments.

FIG. 9 is a schematic diagram illustrating a passive pressure balancing device configured to balance pressures of fluids in four flow channels in embodiments.

FIG. 10 is a diagram illustrating a cross-sectional view of a portion a flow battery cell including an integral pressure balancing element in embodiments.

FIG. 11 is a schematic block diagram illustrating an example electronic controller in embodiments.

FIG. 12 is a diagram illustrating an example orifice check valve in embodiments.

### DETAILED DESCRIPTION

The various embodiments may be described in detail with reference to the accompanying drawings. References made to particular examples and implementations are for illustrative purposes, and are not intended to limit the scope of the invention or the claims.

As used herein, the terms “about” or “approximately” for any numerical values or ranges indicates a suitable temperature or dimensional tolerance that allows the part or collection of components to function for its intended purpose as described herein.

The embodiments discussed herein provide systems, devices and methods useful in energy storage systems based upon a reduction/oxidation (redox) flow battery system, or redox flow battery (RFB) that is suitable for storing and delivering electric energy under a wide variety of conditions. Embodiments of such redox flow battery systems are shown and described in co-pending U.S. patent application Ser. No. 12/498,103, filed on Jul. 6, 2009. The embodiments described herein may also be applied to other electrochemical energy storage systems having two flowing liquid electrolytes.

As used herein, terms which refer to various redox flow battery components with reference to an oxidation or reduction reaction, (including, but not limited to the terms “anolyte,” “anode,” “catholyte,” “cathode,”) are based on a charging reaction convention. Because redox flow batteries involve reversible oxidation/reduction reactions, the actual reactions that occur in each half-cell during a discharge reaction may be the opposite of the reaction that occurs during a charge reaction. Nonetheless, such components may still be referred to herein by their charge-reaction names even when discussing discharge reactions.

The embodiments below include systems and methods for managing, mitigating or reversing pressure and/or flow rate imbalances between positive and negative electrolyte streams. Although some embodiments are described with reference to Fe/Cr flow batteries, the same principles and concepts may also be applied to any other flow battery chemistry in which flow imbalance occurs for any reason.

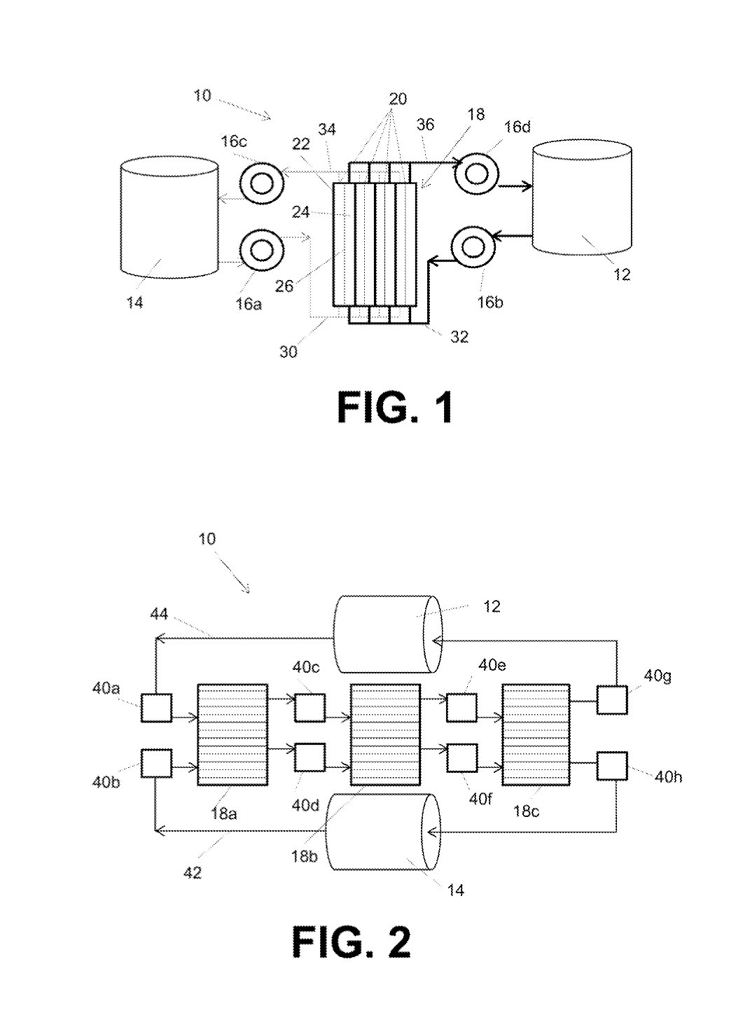

FIG. 1 schematically illustrates a typical two-tank recirculating redox flow battery system 10. For simplicity of illustration and ease of description, electrical connections, load and power source have been omitted, and only liquid electrolyte flow paths are shown. The flow battery system 10 may include an electrochemical stack including at least one block 18 of electrochemical cells 20 which may be configured to convert electrical energy from an electric power source into chemical potential energy in liquid electrolytes flowed through the cell block 18 by pumps 16 and stored in tanks containing negative electrolyte (anolyte) 12 and positive electrolyte (catholyte) 14. The cell block 18 may also be configured to convert chemical potential energy into electric power for delivery to an electric load.

The cell block 18 may include any number of cells 20, each cell having a positive half cell 22 separated from a negative half cell 24 by a separator membrane 26. In some embodiments, the half-cell chambers 22, 24 contain porous electrodes to collect and conduct electrical energy to and from the reacting electrolytes. Positive electrolyte may be pumped from a catholyte tank 14 through a catholyte supply line 30 into the positive half cells 22 and back to the catholyte tank through a catholyte return line 34 by one or more pumps 16. Similarly, the negative electrolyte may be pumped from an anolyte tank 12 through an anolyte supply line 32 into the negative half cells 24 and back to the anolyte tank 12 through an anolyte return line 36 by one or more pumps 16.

In some embodiments an electronic control system may be provided to control the switching of charging from a source and discharging to a load, to control an operation mode of the battery and to perform other control functions. Any suitable digital and/or analog controller may be used to perform the processes described herein, particularly when configured or programmed according to algorithms and logical configurations as also described herein.

In some embodiments, the cell block 18 may include a plurality of individual electrochemical reaction cells joined fluidically and electrically in parallel combination and/or in series combination depending on objectives. Examples of such flow battery systems are shown and described in U.S. Pat. No. 7,820,321 issued on Oct. 26, 2010 to Horne, et al. (“Horne”) and US Patent Application Publication No. 2011/0223450 (Ser. No. 12/986,892) published Sep. 15, 2011 to Home, et al., the contents of both of which are incorporated herein by reference. Reference to the term “cell” or “cells” herein is not intended to be limiting to a specific number of cells. Such references may include reference to one or any number of flow battery reaction cells in any suitable arrangement.

In some embodiments, a plurality of cell blocks may be joined to one another in a cascade arrangement such that electrolyte flows in series from one cell to another or from one cell block to another. For example, engineered cascade redox flow battery systems are described in Horne, in which cells and/or stacks are arranged in cascade orientations, such that electrolyte flows in series from a first stage to an nth stage (where n is any number greater than one) along a common flow path. In those engineered cascade systems, a state-of-charge gradient exists between the first stage and the nth stage, and components of the electrochemical cells are optimized based on the state-of-charge conditions expected at those cells.

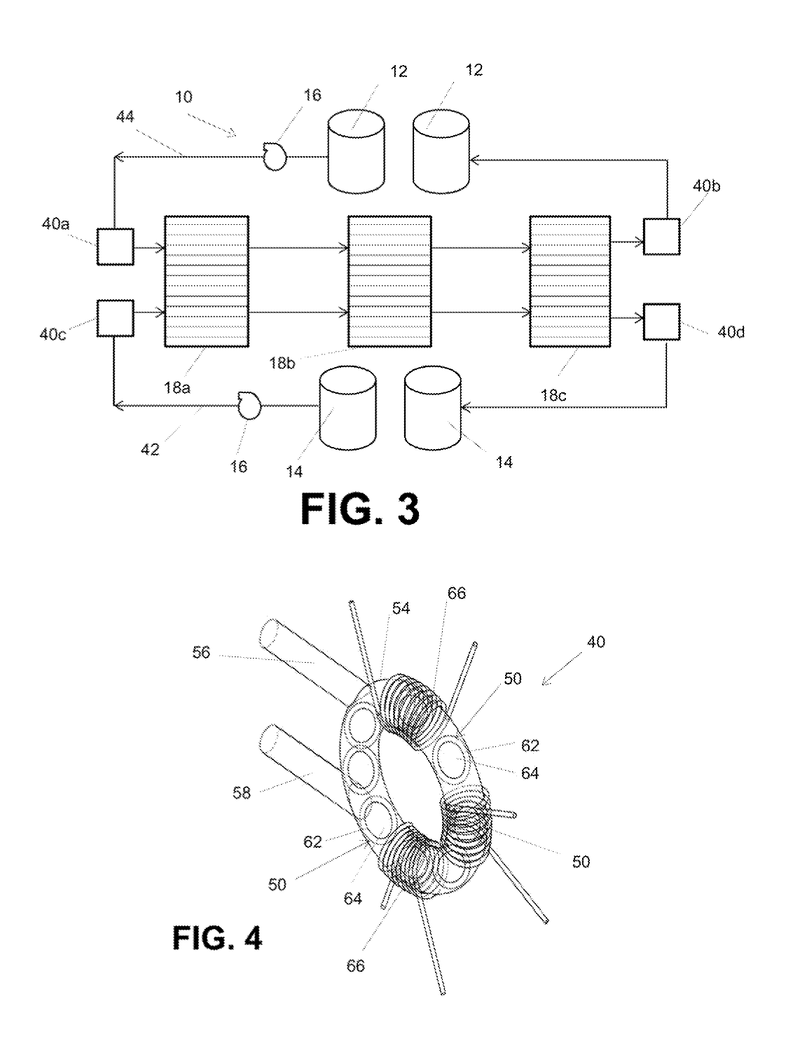

Although the redox flow battery system of FIG. 1 is shown with two tanks, the systems and processes below may also be used in systems with a different number of tanks, such as four-tank systems in which charged and discharged electrolytes are stored in tanks as separate tank volumes. In a typical four-tank flow battery system, electrolytes may be charged and/or discharged through the full design range of the state-of-charge, in a single pass through the stack(s). An example of a four-tank system is shown in FIG. 3. In some embodiments, the benefits of a four-tank system may be achieved by using two tanks, each having a divider, thereby creating four separated tank volumes. Examples of redox flow battery systems with divided tanks are shown and described in Home.

During a normal charging operation, flow battery reactants take up energy by oxidation of a reactant species in the catholyte at the positive electrode (cathode) and by reduction of a reactant species in the anolyte at the negative electrode (anode). During a discharge cycle of the same redox flow battery, energy is released through the reduction of a reactant species in the catholyte at the positive electrode and through the oxidation of a reactant species in the anolyte at the negative electrode.

As used herein, the phrase “state of oxidation” and its abbreviation “SOO” refer to the chemical species composition of at least one liquid electrolyte. In particular, state of oxidation and SOO refer to the proportion of reactants in the electrolyte that have been converted (e.g. oxidized or reduced) to a “charged” state from a “discharged” state. For example, in an RFB based on an Fe/Cr redox couple, the state of oxidation of the catholyte (positive electrolyte) may be defined as the percent of total Fe which has been oxidized from the Fe²⁺ form to the Fe³⁺ form, and the state of oxidation of the anolyte (negative electrolyte) may be defined as the percent of total Cr which has been reduced from the Cr³⁺ form to the Cr²⁺ form.

As used herein, the phrase “state of charge” and its abbreviation “SOC” may refer to the ratio of stored electrical charge (measured in ampere-hour) to charge storage capacity of a complete RFB system. In particular, the terms “state of charge” and “SOC” may refer to an instantaneous ratio of usable charge stored in the RFB to the full theoretical charge storage capacity of the RFB system. In some embodiments, “usable” stored charge may refer to stored charge that may be delivered at or above a threshold voltage (e.g. about 0.7 V in some embodiments of an Fe/Cr RFB system). In some embodiments, the theoretical charge storage capacity may be calculated excluding the effects of unbalanced reaction stoichiometry.

When pumping electrolytes through a redox flow battery cell, an inequality in the bulk volume of liquid electrolyte may often develop over time due to factors such as a pressure difference between the positive and negative electrolytes. The pressure difference may tend to cause migration of liquid across the separator membrane and/or may cause other leakage of liquid electrolyte from one half-cell to another (such as around seals). Various factors may cause this pressure difference. For example, some cells with porous membranes may experience a pressure gradient between a low pressure side (e.g., the catholyte side in some embodiments) and the high pressure side (e.g., the anolyte side in some embodiments) of the membrane. The pressure gradient may cause electrolyte to migrate from the high pressure side to the low pressure side (e.g., from the anolyte side to the catholyte side in some embodiments), thereby causing the volumetric flow rate of the low-pressure electrolyte to be higher at the exit than the low pressure electrolyte. The term “migrating electrolyte or “electrolyte migration” may be used herein in connection with the above described migration and may generally refer to the electrolyte that tends to migrate into the opposite half-cell during normal operating conditions or the phenomena of the migration. The term “receiving electrolyte” may be used herein to identify the electrolyte whose volume is increased as a result of cross-cell leakage or migration. Depending on the flow battery system in question, either of the anolyte or the catholyte may be the migrating electrolyte.

In some embodiments, the pressure gradient may be the result of gas generation, such as hydrogen, oxygen, or other gas, on one side of the membrane (e.g. the anolyte side in some embodiments). In other embodiments, a pressure gradient may result from a relative difference in viscosity, density or other properties of the electrolytes at different temperatures or states of oxidation. In many cases, a pressure gradient between two flow battery electrolytes may result from a combination of factors.

Regardless of the cause of the pressure gradient, electrolyte migration may lead to an excess volume of one electrolyte (e.g. anolyte) and a deficient volume of the other electrolyte (e.g. catholyte). The effect of electrolyte migration may be visible after even a single charge or discharge cycle, and may be further compounded over many cycles. Electrolyte migration may cause system inefficiencies due to the unintended mixing of anolyte and catholyte. Accordingly, correction or mitigation of electrolyte migration may allow long-term operability of a flow battery system to be achieved and sustained.

One known solution to the challenge of addressing electrolyte migration is to begin some or all cycles with an excess volume of the migrating electrolyte (e.g., higher pressure electrolyte). Such an excess volume may be provided in a sufficient amount to cause the system to end up with approximately equal electrolyte volumes after a desired number of charge/discharge cycles. However, such an approach only delays, but does not eliminate the need to re-equalize electrolyte liquid volumes to counteract the problem of electrolyte migration. Another known solution is to equalize electrolyte volumes by transferring the excess volume of receiving electrolyte into a migrating electrolyte tank. However, such an approach necessarily involves mixing relatively large quantities of anolyte and catholyte. Such mixing can have the effect of substantially reducing total energy stored, thereby significantly reducing overall efficiency.

### Flow Control Arrangements for Cascade Flow Batteries

In some cases, it may be impossible or impractical to prevent electrolyte migration from occurring. Accordingly, in embodiments, the electrolyte volumes exiting the stack may be brought back into balance by introducing a flow-resistance to the higher flow-rate electrolyte (e.g., the receiving electrolyte), thereby forcing electrolyte to cross over (e.g., through the separator and/or around leaky seals) in the opposite direction of the normal migration. Forcing such reverse cross-over to occur within the stack may substantially reduce the coulombic efficiency loss due to mixing positive and negative electrolytes.

In some embodiments, the pressure gradient of electrolytes passing through the stack(s) may be balanced by increasing the hydraulic pressure in the low pressure electrolyte (e.g., the receiving electrolyte) flow path and/or decreasing the hydraulic pressure in the high pressure electrolyte (e.g., the migrating electrolyte) flow path until the pressure gradient between the two electrolyte streams is substantially reduced or eliminated. In some embodiments, such pressure balancing may be accomplished by controlling the volumetric flow rates of one or both electrolytes into and/or out of a cell or cell block. In some embodiments, this flow control may be achieved by introducing a flow-resisting force to slow electrolyte flow or a flow-advancing force to increase electrolyte flow using one or more flow control elements in one or both electrolyte streams. Such flow control elements may include pumps, flow metering devices and flow resisting devices. As may be described in further detail below, in some embodiments flow control elements may be automatically controlled based on one or more measured flow rates or pressures.

Embodiments of flow metering devices may include many structural elements or configurations. In some embodiments, a flow metering device may be a pump. For example, metering pumps may be provided for each of the anolyte and catholyte fluid paths between each stage of the cascade. A metering pump (or flow control pump) may be any type of pump capable of both producing a forward pumping pressure and resisting a forward pressure greater than the desired flow rate. Thus, a metering pump may be any type of pump capable of providing the desired flow rates. For example, metering pumps may include peristaltic pumps, centrifugal pumps, bellows pumps, diaphragm pumps, piston pumps, positive displacement pumps, gear pumps, progressing cavity pumps (e.g., screw pumps), nutating disk flow meters, piston pumps, or other suitable flow-control pumps. Examples of such devices are shown and described in co-pending U.S. Patent Application Publication No. 2012/0308856, published Dec. 6, 2012, based on U.S. patent application Ser. No. 13/312,802, entitled “Shunt Current Resistors For Flow Battery Systems” filed Dec. 6, 2011, which claim priority to U.S. Provisional Application No. 61/421,049 filed Dec. 8, 2010, the contents of all of which are incorporated herein by reference.

FIG. 1 illustrates a two-tank recirculating flow battery system in embodiments in which electrolytes may be circulated between tanks 12, 14 and the reaction stack 18 in which electrolytes are charged or discharged. In some embodiments, flow control devices 16a, 16b, 16c and 16d may be positioned at both an inlet to and an outlet from a cell block 18 of a recirculating system. In some embodiments, flow control devices 16a-16d may comprise flow metering pumps. In some embodiments, the flow control devices 16a-16d may comprise any other flow control device such as valves, narrow flow channel restrictions, nozzles, narrow orifices, or other devices.

In some embodiments, the role of two flow control pumps may be performed by a single pump with multiple heads configured to pump multiple flow paths under the same pumping power. In an example, electrolyte may be pumped by a first pair of pumps 16a, 16b from the tanks 12, 14, into a cell block (or stage) 18 via inlet lines 30, 32, and then out of the block 18 through outlet lines 34, 36, and back into the tanks 14, 12 by a second pair of pumps 16c, 16d. Such an arrangement may be configured to force both electrolytes to enter and exit the cell block at the same volumetric flow rate.

In other embodiments, the system of FIG. 1 may include only inlet-side pumps 16a or outlet-side pumps 16b with the remaining flow control managed by flow control devices of any other type. In some embodiments, the arrangement of FIG. 1 may be extended for any number of cell blocks.

FIG. 2 illustrates a cascade flow battery system 10 in embodiments. The cascade battery system 10 may have three independent cell blocks 18 fluidically connected to one another in series. In the example of FIG. 2, the concept of flow control devices in the context of a single cell block may be expanded to a cascade configuration of cell blocks by providing flow control devices 40 before and after each individual cascade stage 18a-18c in an interleaved arrangement. In embodiments, flow control devices 40 may be provided in both the catholyte flow path 42 and the anolyte flow path 44 at positions before and after each cell block 18 in the cascade. Flow control devices 40 provided in this interleaved arrangement may be used to control the hydraulic pressure in each electrolyte stream to substantially limit or eliminate any flow rate difference between the two electrolyte streams.

Alternatively, flow control devices 40 may be provided only at positions between adjacent cell blocks 18. In such examples, flow control devices 40a, 40b, 40g and 40h as shown in FIG. 2 may be omitted or replaced by pumps 16 that need not be metering pumps. In further alternatives, a flow battery system may be configured such that each individual electrochemical cell within a block 18 includes flow control structures configured to minimize a pressure gradient between the anolyte and catholyte.

FIG. 3 illustrates a cascade flow battery system 10 in embodiments. The cascade flow battery system 10 includes flow control elements 40a, 40b, 40c, 40d positioned at cascade ends (inlets and outlets). In the example of FIG. 3, a first flow control device 40a may be positioned in the anolyte flow path 44 upstream from an inlet to a first cascade stage 18a and a second flow control device 40b may be positioned in the anolyte flow path 44 downstream from an outlet of a final cascade stage 18c. Similarly, flow control devices 40c and 40d may be provided in the catholyte flow line before an inlet to the first stage 18a and after an outlet from the final stage 18c.

The terms “inlet” and “outlet” as used herein assume an electrolyte flow in the direction shown. Some flow battery systems may be configured to operate with flow in only one direction, but in various embodiments, the cascade flow battery system may be configured such that electrolytes may flow in both directions through the cascade. For example, the electrolytes may flow from left-to-right during charging, and from right-to-left during discharging. In such cases, the terms inlet and outlet may refer to the relevant positions relative to an intended flow direction in a given case.

In various embodiments, any number of cascade stages may exist between pairs of flow control devices 40 (e.g., 3, 4, 5, 6, 7, 8 or more stages). In some embodiments, a system, such as the system of FIG. 2, may be controlled by increasing or decreasing a flow resistance applied by any or all of the flow control devices 40a-40d to the electrolytes flowing through them.

In the arrangement of FIG. 3, flow control devices 40 between cascade stages may be omitted. In some embodiments, in operation, an arrangement, such as the arrangement of FIG. 3, may utilize flow control devices at the cascade outlet only (e.g. 40b and 40d in the flow direction shown), so as to force electrolyte to cross-over (e.g., through the separator and/or around leaky seals) in the opposite direction of the normal migration. Placing flow control devices at an outlet end of a cascade may cause such reverse cross-over to occur within the cascade, but toward the outlet end of the cascade. In such embodiments, the flow control devices 40a, 40c at the inlet end may be operated so as to minimize any flow restriction at the cascade inlet, allowing pumps or other devices (not shown) to cause electrolytes to flow into the cascade at substantially equal flow rates.

In some embodiments, all four flow control devices 40a, 40b, 40c and 40d may be metering pumps or flow control pumps, and pumps 16 may be omitted. The pumps 40a and 40c at the inlet end may operate only as pumps to drive electrolytes through the cascade at equal flow rates, and either or both of the pumps 40b and 40d at the outlet end may be operated as flow resistors to cause electrolyte flow rates (and/or pressures) of electrolytes exiting the cascade to be equal or substantially equal. The flow direction may be reversed, such as when switching from charging to discharging, and the roles of the pumps may accordingly be reversed such that pumps 40b and 40d drive electrolytes through the cascade while the pumps 40a and 40c may be configured to operate as flow resistors.

In other embodiments, a flow control arrangement may have flow control devices in only one electrolyte line, such that flow of only a single electrolyte is actively controlled. For example, when it is known that, without intervention, the anolyte exiting the stack will have a higher flow rate than the catholyte (e.g., the catholyte is the migrating electrolyte), flow control devices may be placed only in the anolyte flow lines in order to control the flow rate of the anolyte sufficiently such that the flow rate of the anolyte exiting the cell block is equal or substantially equal to the flow rate of the catholyte exiting the cell block. In an alternate example, when it is known that, without intervention, the catholyte exiting the stack will have a higher flow rate than the anolyte exiting the stack (e.g., the anolyte is the migrating electrolyte), flow control devices may be placed only in the catholyte flow lines in order to control the flow rate of the catholyte sufficiently such that the flow rate of the catholyte exiting the cell block is equal or substantially equal to the flow rate of the anolyte exiting the cell block.

The choice of which configuration should be used, such as the book-end arrangement of FIG. 3, the interleaved arrangement of FIG. 2, controlling pressure at inlets, outlets, or both, or other configurations, may depend on characteristics of the flow battery system, the nature of cross-over, whether a cascade or recirculating stack is being used, the number of stages in a cascade, cell properties (e.g., separator materials, electrode materials, . . . ), or other factors. For example, in some systems, the electrolyte migration pattern may be such that the interleaved arrangement whereby flow resistors may be placed in between each cascade stage may actually cause greater overall efficiency losses than an arrangement in which pressures (and/or flow rates) are only balanced by flow resistors at the outlet of the final cascade stage. For example, in a long enough cascade, the volume of migration from one electrolyte into the other may reach a plateau at some stage in the cascade at which point flow rates remain constant (though un-equal). Correcting electrolyte migration by creating a flow restriction only at the outlet end of such a cascade may causes less coulombic efficiency loss than correcting electrolyte migration with flow resistors after each stage, particularly when balancing pressures or flow rates after each stage is likely to cause a greater total volume of electrolyte migration. Therefore, in some embodiments, it may be desirable to impose a flow restriction on the higher flow-rate electrolyte (e.g., the receiving electrolyte) only at the outlet of a cascade. Thus, for a reversible cascade, flow control devices may be positioned at both ends of the cascade. In embodiments, the flow control devices may be configured such that only the flow control device or devices at the cascade outlet end may be operated to resist electrolyte flow during a particular flow cycle. When the flow cycle is reversed, the flow control devices at the other outlet end may be configured to resist electrolyte flow when the cascade is reversed.

Flow control devices may include flow restriction or flow resistance mechanisms configured in arrangements, such as the arrangements illustrated in FIG. 1 through FIG. 3, or any other arrangements. The flow control devices and may include any available flow control device or devices, some examples of which are described below.

### Flow Control Devices

In some examples, a flow control device may be a flow resistor. Flow resistors may be constituted as structures similar to pumps. In other examples, flow resistors may be different from pumps in that a flow resistor need not necessarily be capable of producing a positive pumping pressure between its inlet and its outlet. Rather a flow resistor may be any electromechanical or purely mechanical device that is configured to create or present a back-pressure that resists the fluid flow, such as an orifice or series of orifices of a particular diameter or diameters to cause a resistance to flow. Such a flow resistor may be useful in situations when the degree of required pressure control or flow resistance is known. A flow resistor may present a back-pressure, including a predetermined or known back-pressure, or a back-pressure that varies according to a known profile depending on the input pressure of the fluid flow. In some embodiments, flow resistors may also be configured to produce a variable back pressure that may be manually or automatically-controlled. Some circulating flow battery systems, for example ones that may utilize a single pump in each electrolyte circulation stream, whether upstream or downstream of the battery cell, are incapable of producing or controlling backpressure within the battery cell. The embodiments disclosed herein are advantageous as being capable of establishing back pressures within a cascade RFB configuration or other RFB configurations to address the problems associated with electrolyte migration.

In further embodiments, a flow-resisting force may be applied to the electrolyte flow using rotating mechanical elements with structures that may also be configured to resist electrical shunt currents flowing in electrolyte flow channels. For example, mechanical shunt resistor examples may include structures such as flow meter devices with a rotating element attached to a rotating shaft or axle for the purpose of providing a barrier to shunt currents while allowing free flow of the fluid. In embodiments, mechanical shunt resistors may be modified with a brake or clutch configured to apply a frictional force to the rotating motion that may also provide a flow resistance. Other shunt resistor devices are shown and described in U.S. Patent Application Publication No. 2012/0308856 incorporated herein above. Such shunt resistor devices may include active or passive shunt resistors of any type are preferably made of a material that is substantially electrically non-conductive (i.e. having a substantially high electrical resistance) and chemically non-reactive (i.e. having substantially inert chemistry in the electrolyte environment). Materials useful in forming shunt resistors may include some gas bubbles (e.g., an inert gas), glass, some ceramics, rubber, or any of various non-conductive polymers, such as polyethylene, polypropylene, polyvinyl difluoride, perfluoroalkoxy, or polyvinyl chloride, among others. Shunt resistors may be moving fluid-isolating structures that restrict the flow of electrolyte and create fluidic isolation between the inlet and outlet side. Non exhaustive and non-limiting examples of shunt resistors may include long channel shunt resistors, pumps or pump-like devices, gears or gear pumps, screw pumps, progressive cavity pump, paddle wheel pumps, impellers, positive displacement pumps, positive-displacement flow meters, diaphragm pumps, nutating disk flow meters, reciprocating piston pumps, peristaltic pumps, and other mechanisms. Shunt resistors may further be configured to resist fluid flow and produce a back pressure, or may further be configured to be controlled to resist fluid flow and produce variable back pressure, for example, based on a control signal.

Other shunt resistor examples, which may be configured to resist flow, are possible. For example, FIG. 4 illustrates a shunt resistor 40 having a plurality of powered coils 66 surrounding sections of the shunt resistor channel 54. The dividers 50 may be configured in a spherical, nearly spherical or ellipsoid shape and may include an outer portion 62 surrounding an inner portion 64 constructed from a magnetic core material, which may be a ferrous, ceramic, rare earth or other magnetic material. The dividers 50 may also be configured in a non-spherical, elongate shape, selected and arranged such that the magnetic poles of the core material are aligned with a longitudinal axis of the dividers. In some embodiments, the dividers 50 may be mechanically connected to a common central shaft. When coils 66 are de-energized, the dividers 50 may move freely within the shunt resistor channel 54 and present little or no resistance to fluid flow in the shunt resistor channel 54. However, the dividers 50 may nevertheless present a barrier to shunt currents.

Applying an electric current to one or more of the coils 66 energizes the coils and generates a magnetic field according to know principles of electromagnetism. The magnetic field may have a core concentration of magnetic flux within the central axis of the coil, which may be coaxial with the shunt resistor channel 54 along the flow direction and the direction in which the dividers 50 may travel. The magnetic field/flux concentration may have “north” and “south” poles at respective ends of the coil and in respective portions of the shunt resistor channel 54 around which the coil 66 is wound. The poles of the magnetic field may attract opposite poles and repel like poles of the magnetic cores of dividers 50, which are adjacent to the coils 66 within the shunt resistor channel 54. The action of the magnetic field on the dividers 50 may have a position and movement modulating effect on the dividers 50 that may restrict the flow of fluid through the shunt resistor channel 54. By controlling the timing of the application of electric currents to each of the coils 66, the generation of magnetic fields may be controlled such that the movement of the dividers 50 may be correspondingly controlled to predominantly resist forward motion of the dividers through the channel 54. Varying the magnitude of the electric currents applied to the coils 66 may correspondingly vary the magnitude of magnetic forces applied to the dividers 50. Thus, by controlling the timing and magnitude of applied electric currents, the device of FIG. 4 may control the rate of flow of circulating electrolytes therethrough, thereby controlling the back pressure of fluid flowing between the inlet 56 and the outlet 58. Similarly, the device of FIG. 4 may be operated as a pump to increase a rate of electrolyte flow from the inlet 56 to the outlet 58. Alternatively, a magnetic or electromagnetic force may be applied to a shunt resistor such as that shown in FIG. 4 in such a way that causes increased friction between the dividers 50 and an inner wall of the channel in which they travel, thereby causing controlled resistance to flow by friction.

In alternative embodiments, flow resistors may include valves configured to counteract a pressure difference between the two electrolytes. For example, in some embodiments a flow control valve may be used as a flow resistor. Such flow control valves may include ball valves, gate valves, globe valves, diaphragm valves, butterfly valves, needle valves, poppet valves, solenoid valves, etc. Such valves may be automatically controlled so as to provide a variable flow resisting force in response to a control signal. In various embodiments, such a control system may be entirely electronic, electromechanical, hydraulic, and pneumatic or may involve any other actuation or control method.

In some embodiments, a flow control device may be controlled through a closed loop automatic control system based on a measured control parameter, such as a hydraulic pressure or a flow rate of one or both electrolytes measured at one or more points in a flow path. In some embodiments, electrolyte flow may be adjusted by one or more automatically-controlled flow metering devices configured to directly control an electrolyte flow rate by metering flow with one or more mechanical elements (e.g., flow-control pumps).

### Pressure or Flow Control Systems

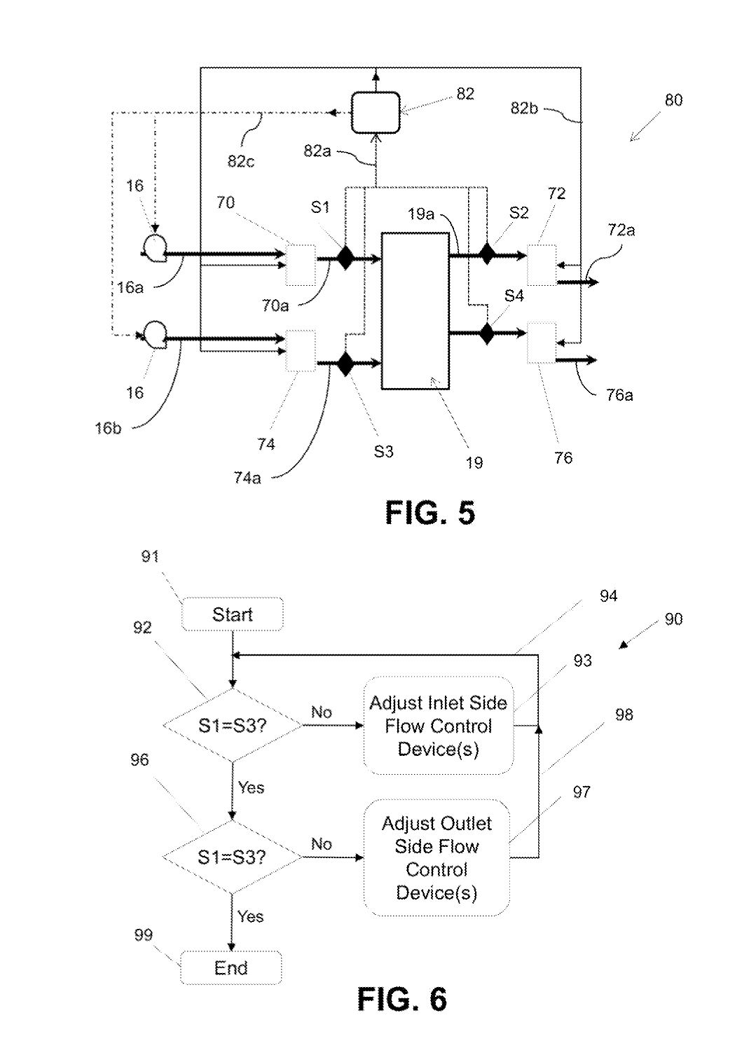

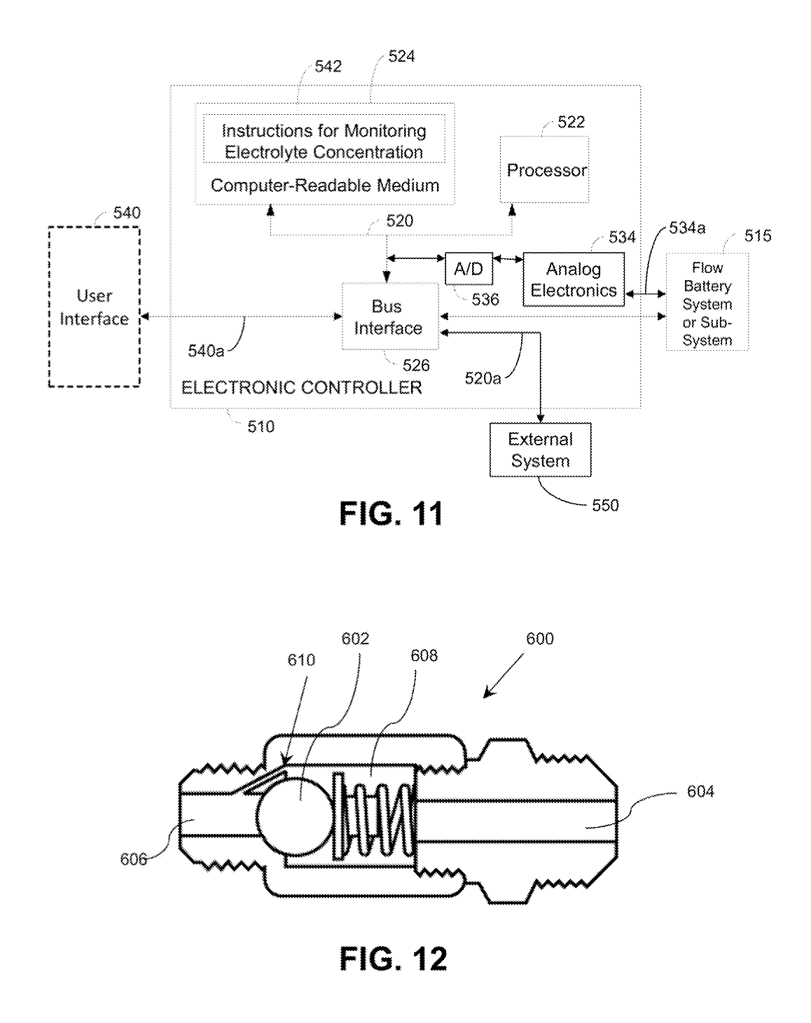

Various control algorithms may be used for automatically determining the degree to which one or more electromechanical flow control devices should increase or decrease a pressure or a flow rate. Examples of such algorithms are described below with reference to FIG. 5 and FIG. 6. Such algorithms may use any suitable electronic controller, an example of which is described below with reference to the block diagram of FIG. 11.

FIG. 5 illustrates one example of elements that may be involved in a closed-loop flow control system 80 for controlling a pressure balancing system relative to a control block of cells 19 in embodiments. The control system 80 may include an electronic controller 82 configured to receive measurement signals 82a from sensors S1, S2, S3 and S4, which may be pressure sensors in some embodiments. The controller 82 may also be configured to transmit control signals 82b to flow control devices 70, 72, 74 and 76. Lines 16a, 16b, 70a, 74a, 19a, 19b, 72a and 76a may represent electrolyte flow paths carrying electrolyte flowing through the control block of cells 19, for example, from left to right. In some embodiments pumps 16 may be configured to drive the flow of electrolyte in lines 16a and 16b through the control block 19 and may receive control signals 82c from the controller 82. In embodiments, some or all of the flow control devices S1, S2, S3 or S4 may comprise pumps, in which case, one or both of the pumps 16 may be omitted. In some embodiments, the control block 19 may include only a single cell block. In other embodiments, the control block 19 may comprise a complete cascade of cell blocks with any number of stages. In embodiments, one or more of the sensors S1, S2, S3, or S4, or flow control devices 70, 72, 74, and 76 may be omitted if such devices are not needed for a particular control algorithm.

In embodiments, a first set of sensors S1, S3 may be placed in each electrolyte flow path, for example, on an inlet side of the control block 19. A second set of sensors S2, S4 may be positioned, for example, at an outlet side of the control block 19. In embodiments, the sensors S1, S2, S3, and S4 may be pressure sensors. The control system, through operation of the controller 82, the sensors S1, S2, S3, S4 and the flow control devices 70, 72, 74, and 76 may be configured to increase or decrease a flow resistance applied by the flow control devices 70, 72, 74, 76 until the pressure measured by the outlet-side sensors S2, S4 and/or the inlet-side sensors S1, S3 reaches a desired level. Thus, in embodiments, a control system may be configured to control flow control devices based on measured pressures to maintain a state in which, for example, the inlet pressures in the line 70a and 74a are substantially equal to one another, and the outlet pressures in the line 19a and 19b are substantially equal to one another. The outlet pressures may typically be lower than the inlet pressures by a designed pressure drop for the control block 19.

In embodiments, hydraulic pressure in inlet and outlet electrolyte flow lines 70a, 74a, 19a, and 19b, may be continuously monitored by respective ones of the pressure sensors S1, S2, S3, and S4. In embodiments, a difference in pressure detected by the two outlet sensors S2, S4 may be equalized or otherwise controlled, by increasing the pressure in the lower-pressure flow line by operating the outlet-side flow control device (72 or 76) in the one of the flow lines, such as in the lower-pressure flow line. For example, if the sensor S2 detects a higher pressure than the sensor S4, a flow resistance of the outlet flow control device 76 may be increased until the pressure sensed in the sensor S2 is substantially equal to the pressure sensed in the sensor S4. Alternatively, a pressure difference sensed between the electrolyte flow lines may be balanced, or otherwise controlled by operating both an inlet-side flow control device such as the flow control device 70 or 74, and an outlet side flow control device such as the flow control device 72 or 76, to increase the pressure of the lower-pressure flow line. Further, for example, if the pressure sensed by the sensor S2 is relatively higher than the pressure sensed by the sensor S4, flow resistance may be increased by both the inlet-side flow control device 74 and the outlet side flow control device 76 until the outlet pressure sensed at the sensor S4 is substantially equal to the pressure sensed at the sensor S2. In embodiments, the flow resistance applied at the inlet and outlet flow control devices (e.g. 74 and 76) may be substantially equal to one another.

In embodiments, a pressure-control system may be configured to maintain a state in which an inlet pressure of one electrolyte is higher than an inlet pressure of the second electrolyte by a predetermined amount. For example, it may be desirable to maintain a naturally high-flow-rate electrolyte at a higher pressure than the second electrolyte. Similarly, the pressure-control system may be configured to maintain a state in which an outlet pressure of one electrolyte is higher than an outlet pressure of the second electrolyte by a predetermined amount. In embodiments, an inlet pressure, an outlet pressure, or both an inlet pressure and an outlet pressure of one electrolyte may be controlled to be higher or lower than the other electrolyte by a predetermined amount. Thus, in some embodiments, the control system may be configured to adjust an inlet-side flow control device 70, 73 and/or an outlet-side flow control device 72, 76 to maintain the desired relative pressures.

In alternative embodiments, the sensors S1, S2, S3, S4 may be flow rate sensors, and a flow imbalance between the catholyte and the anolyte may be balanced by adjusting flow control devices 70, 72, 74, 76 to meet flow rate targets. In some embodiments all four measured flow rates may be controlled to be substantially equal to one another. In other embodiments, the flow rate at each inlet or outlet may be controlled individually to achieve desired balances between flow rates in respective flow lines.

The process flow diagram of FIG. 6 illustrates a high-level control process that may be used to accomplish control in embodiments. The process of FIG. 6 may be described with reference to the system of FIG. 5 and assuming electrolyte flow in the direction shown in FIG. 5. The controller 82 may include a processor to be described in greater detail hereinafter configured to execute the algorithms and processes as described herein. With reference to FIG. 6, the process 90 may begin at start block 91 and may evaluate the measurement signals of the sensor S1 and S3, for example, on the inlet-side of the control block 19, such as by comparing sensor output data values in a processor or controller, such as controller 82. When the sensor output data values indicate that the pressures (or flow rates) in the electrolyte supply lines are not equal or substantially equal to one another (e.g., determination block 92=“NO”) the controller 82 may send control signals to adjust 93 one or both of the inlet-side flow control devices 70, 74 with the objective of bringing the pressures or flow rates closer to equality in block 93. The sensor output data values may be determined to be different when an error value or difference value between the sensor output data values is greater than an acceptable error or difference threshold value. Alternatively, when an error value or difference value exceeds a threshold, the controller 82 may send control signals to adjust one or both pumps 16 in order to equalize pressure and/or flow rate at the inlet. Evaluating inlet pressure or flow rate and adjusting inlet-side flow control elements in blocks 92 and 93 may be repeated through path 94, as many times as needed until an error value or difference value between the inlet-side sensor output data values is below the desired error or difference threshold.

When the inlet pressures and/or flow rates as determined by the sensor data output values of the sensors S1 and S3 are equal or sufficiently or substantially equal (e.g., determination block 92=“YES”), the controller 82 may evaluate measurement signals for pressures and/or flow rates of the sensors S2 and S4 at the outlet side of the control block 19. When the outlet pressures or flow rates, as determined by comparing the sensor data output values of the sensors S2 and S4, are not equal or substantially equal to one another (e.g., determination block 96=“NO”), the controller 82 may send control signals to adjust one or both of the outlet-side flow control devices 72, 76 to make adjustments in block 97 in order to reduce the error. The determination of whether the sensor data output values are equal or substantially equal may be made by a determining whether an error value or difference value between the sensor output data values is greater than an acceptable threshold value. The steps of evaluating outlet pressure or flow rate and adjusting outlet-side flow control elements in blocks 96 and 97 may be repeated through path 98 as many times as needed until an error between the outlet-side sensors is below a desired threshold.

The process of FIG. 6 is intended to be illustrative and non-limiting and may exemplify a process in which the inlet side flow parameters may be substantially equalized and outlet-side flow parameters may be evaluated and adjusted. In embodiments, the inlet side and outlet side flow parameters may be evaluated and adjusted simultaneously. In embodiments, inlet side flow parameters may be optimized independently of outlet side parameters, and vice versa. In embodiments, inlet side flow parameters may be optimized by also evaluating and adjusting outlet-side flow parameters, and vice versa. Other combinations of evaluating pressure differences and adjusting inlet and outlet flow parameters may also be possible in embodiments.

### Integral Flow Control and Pressure Sensing Device

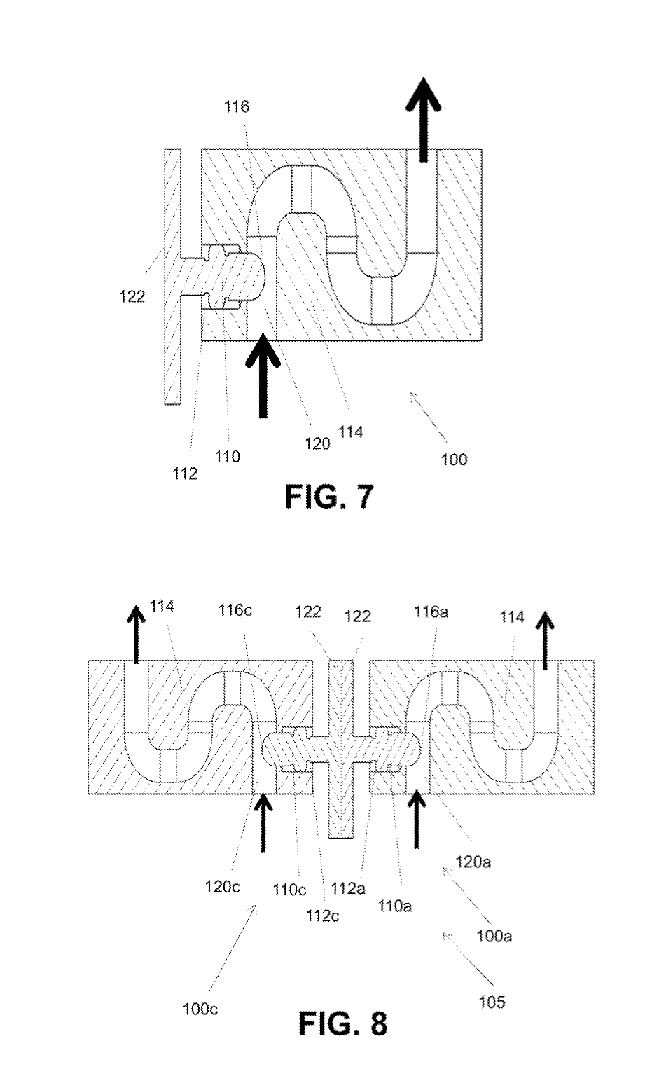

In embodiments, flow control devices may be integrated into a cell block. For example, flow control devices may be incorporated into an end plate of one or more cell blocks. In embodiments, flow control devices may be incorporated into a central portion of a cell block and/or directly within cell layers. Examples of embodiments are shown in FIG. 7-FIG. 10.

In embodiments, a flow control device may be integrated with a pressure sensing device. FIG. 7 illustrates a flow control and pressure sensing device that may be incorporated into a flow battery system in embodiments. The device of FIG. 7 may be incorporated into an inter-stage plate configured to join adjacent cell blocks of a cascade flow battery system. Alternatively, the device of FIG. 7 may be integrated into an end plate of a block of cells. The structures of FIG. 7 and FIG. 8 are provided as illustrative and non-limiting examples. Functionally similar pressure balancing devices, which may be available in many physical forms and shapes, may also be used.

The flow control and pressure sensing device 100 of FIG. 7 may include a plunger 110 slidably positioned within a channel 112 in a plate body 114. A distal end 116 of the plunger 110 may extend into an electrolyte flow channel 120, which may be an inlet or an outlet of a flow battery cell block. In some embodiments, the plunger 110 and/or the plunger channel 112 may include one or more seals (e.g. O-rings) for preventing leakage of electrolyte from the flow channel 120 into the plunger channel 112. In embodiments, the plunger 110 may be a rigid device, slidably disposed in a channel 112. In embodiments, the plunger 110 may be a flexible device, such as an inflatable or expandable member disposed in plunger channel 112, and configured to enclose or restrict the flow channel 120 on inflation or expansion.

The plunger 110 may be free to slide, expand, or contract within the channel 112 such that hydraulic pressure within the flow channel 120 will tend to push the plunger 110 in or out of the channel 112. In some embodiments, a force pushing the plunger 110 out of the flow channel 112 or contracting the plunger 110, may be proportional to a hydraulic or pneumatic pressure within the flow channel 120. The force by which the plunger 110 is pushed out of the flow channel 120, or by which the plunger 110 is contracted, may be measured by a sensor device (not shown). By contrast, applying a force to a bearing surface 122 of the plunger 110, for example, by an actuator or other driving mechanism (not shown) and pushing the plunger 110 into the flow path 120 may impede flow of electrolyte through the flow channel 120, thereby increasing hydraulic pressure in the electrolyte upstream of the plunger 110. In some examples, the actuator and sensor may be combined in the same mechanism. Thus, embodiments of the device 100 of FIG. 7 may provide both measurement and control of hydraulic and pneumatic pressure of fluids in the electrolyte flow channel 120.

As discussed above, in embodiments it may be desirable to increase a hydraulic pressure of one electrolyte (e.g., an anolyte) to substantially match a hydraulic pressure of the second electrolyte (e.g., a catholyte). Thus, in embodiments, a pair of pressure sensing and control devices 100 may be combined to form a passive automatic pressure balancing device. Such a device is shown in FIG. 8.

FIG. 8 illustrates a passive automatic pressure balancing device 105 in embodiments. The passive automotive pressure balancing device may include a pair of pressure sensing and control devices 100 coupled to one another in order to balance hydraulic pressures in a corresponding pair of electrolyte flow channels. In embodiments, a common end plate 114 may include an anolyte flow channel 120a and a catholyte flow channel 120c. A pair of plungers 110a, 110c may be slidably disposed in respective channels 112a, 112c and may extend into a section of each flow channel 120a, 120c, respectively. In embodiments, bearing surfaces 122 of the two plungers may be mechanically coupled to one another, such that movement of a distal end 116c of one plunger 110c out of a flow channel 120c may have the effect of applying a force that is applied through the coupled bearing surfaces 122 so as to move the other plunger 110a within channel 112a and into the flow channel 120a. Thus, a relatively high pressure in flow channel 120c has the effect of pushing the plunger 110a into the flow channel 120a to restrict the flow in flow channel 120a and effectively increase the pressure in the flow channel 120a. When the pressure in the flow channel 120a increases to a level that overcomes the pressure in flow channel 120c, the process may reverse and the plunger 110c may be pushed back into the flow channel 120c to increase the pressure therein. Because the action is passive, pressures may be continuously balanced by reciprocal action of the plungers 110a and 110c in response to changing pressures in the respective flow channels 120a and 120c.

In embodiments, the plungers 110a and 110c may be indirectly mechanically coupled such as by means of a spring, a flexible bladder, a lever, a gear or other mechanical elements (not shown). In embodiments, a plunger 110 of one flow control and pressure sensing device may be coupled to the plunger 110 of a second flow control and pressure sensing device by a conduit filled with an incompressible fluid (e.g., water, oil, an electrolyte, . . . ).

In embodiments, each plunger 110 may be coupled to an electronic detector configured to detect a force imparted to the plunger 110 by a fluid in the flow channel 120. In embodiments, each plunger 110 may also be coupled to an electromechanical actuator (e.g., a solenoid, servo motor or other electronically-controlled mechanical actuator) configured to drive the plunger 110 into or out of the flow channel 120 in response to an electronic control signal.

In embodiments, the passive automatic pressure balancing device 105 of FIG. 8 may be used to balance pressure between anolyte and catholyte flow streams in a block of electrochemical cells. A first passive automatic pressure balancing device 105 may be positioned at an inlet to a block of electrochemical cells. A second passive automatic pressure balancing device 105 may be positioned at an outlet from the block of electrochemical cells. In embodiments, the passive automatic pressure balancing device 105 may be positioned at an inlet to or an outlet from a single cell block. In embodiments of a multi-stage cascade arrangement, the passive automatic pressure balancing device 105 may be positioned between adjacent stages such that each flow channel 120a, 120c joins an outlet from a first stage to an inlet to the adjacent stage. In embodiments, the passive automatic pressure balancing device 105 may be placed at either end of a multi-stage cascade arrangement. It may also be desirable to position the automatic pressure balancing device 105 at an outlet end of a multi-stage cascade arrangement.

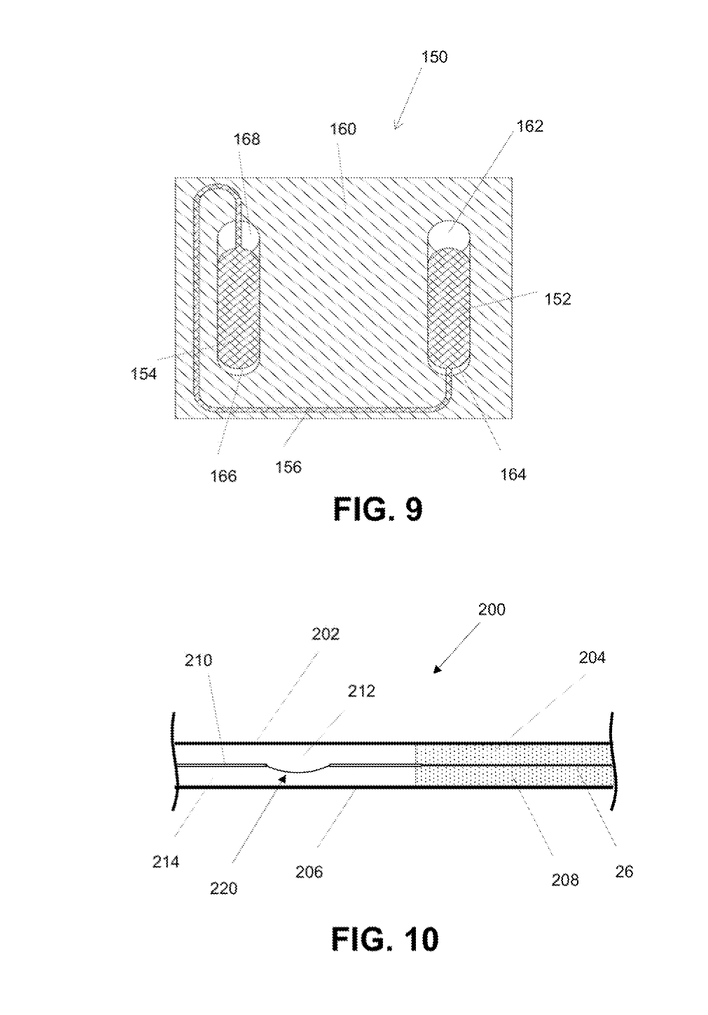

FIG. 9 is a schematic illustration of a pressure balancing device 150 configured for passively balancing pressures in a cell block in embodiments. A device such as that shown in FIG. 9 may be formed in a base plate 160, which may be integrally formed with a cell block structure, such as an end plate or a side plate. The pressure balancing device 150 may include plungers 152, 154 joined by a cable 156. The plungers 152, 154 and the cable 156 may be slidably positioned within channels in plate 160. In embodiments, the cable 156 may have sufficient axial stiffness to allow forces to be transmitted in both directions between the plungers 152, 154. In other words, the cable 156 may be configured such that movement of the plunger 154 may push or pull the plunger 152, and movement of the plunger 154 may push or pull the plunger 152. The cable may comprise any suitable structure, such as a chain, a mechanical linkage, a hydraulic piston or other hydraulic motion control device. Further, the cable 156 may include any other suitable motion control device capable of transmitting forces bidirectionally between the plungers 152 and 154. As with other embodiments described herein, the plungers 152, 154, plate 160 and other components that may potentially come into contact with and be wetted by caustic electrolyte, may have at least an outer surface thereof made of a material that is resistant to degradation from electrolyte contact.

The base plate 160 may be joined in fluid communication with electrolyte flow lines such that electrolytes flow into and/or out of ports 162, 164, 166, 168. In one example, the port 162 may be joined to an anolyte inlet leading into the cell block 160. The port 164 may be joined to a catholyte inlet leading into the cell block 160. The port 166 may be joined to an anolyte outlet exiting from the cell block 160. The port 168 may be joined to a catholyte outlet exiting from the cell block 160. Any suitable fluidic connection arrangement may be used to connect the ports 162, 164, 166, and 168 to the respective electrolyte flow lines. The relative pressures of electrolytes flowing through the electrolyte flow lines and the ports 162, 164, 166, 168 may impart forces to ends of the plungers 152, 154 that extend into the respective ports. A plunger may move in response to the forces and cause corresponding movement in the plunger connected by the cable 156.

With continued reference to FIG. 9, for example, when anolyte exiting the cell block 160, for example, at port 166 is at a relatively higher pressure than catholyte exiting the cell block 160 at port 168, the plunger 154 may be pushed away from the port 166 at least partially opening the anolyte exit flow and pushed toward the port 168 at least partially closing the catholyte exit flow. The partial opening and closing may be proportional to the relative pressure difference between the port 166 and the port 168. The effect of the movement of the plunger 154 may be to restrict catholyte exit flow thereby increasing the pressure in the catholyte flow path, and to open the anolyte exit flow thereby decreasing the pressure in the anolyte flow path. Correspondingly, the cable 156 may transmit the force of the movement of the plunger 154 to plunger 152. The force in the cable 156 may cause the plunger 152 to move toward the port 162 and at least partially close the anloyte inlet flow. The plunger 152 may move away from the port 164 and at least partially open the catholyte inlet flow. The effect of the movement of the plunger 152 may be to restrict the anolyte inlet flow thereby causing a further decrease in pressure in the anolyte flow path and to open the catholyte inlet flow thereby causing a further increase in pressure in the catholyte flow path. In the above example, ports 162 and 168 may be reversed, e.g. port 162 may be associated with a catholyte outlet and port 168 may be associated with an anolyte input with the same effect. Other configurations are also possible of the ports 162, 164, 166 and 168 (e.g., relative to anolyte and catholyte inlets and outlet), the plungers 152 and 154 and the cable 156 with the same effect.

In embodiments, the plungers 152, 154 may be sized and shaped so as to generate a sufficiently large pressure change to balance out at least half of a maximum expected pressure difference between electrolytes. The plungers 152, 154 may be sized relative to the channels in which they travel such that the channels are substantially sealed to prevent electrolyte flow or leakage between the plungers and the channels. Similarly, the cable 156 may be sized and configured to seal the cable channel against electrolyte flow or leakage.

FIG. 10 illustrates a pressure balancing structure integrated into a single cell 200 in embodiments. The cell 200 of FIG. 10 may be a single cell within a bipolar stacked cell block that may also include any number of additional cells such as in a cascade arrangement. The cell 200 may comprise a first bipolar plate 202 separating a first half cell compartment 204 from an adjacent cell (not shown), and a second bipolar plate 206 separating the second half-cell compartment 208 from an adjacent cell (not shown). The first and second half cell compartments may be at least partially filled by porous conductive electrode materials (e.g., carbon or graphite felt), and the first and second half-cell compartments 204, 208 may be separated from one another by a separator membrane 26.

In embodiments, the cell 200 may also include a divider layer 210 that surrounds a portion of the separator membrane 26 and provides flow channels 212, 214 through which respective electrolytes (e.g., anolytes, catholytes) may pass when entering or exiting the half-cell chambers 204, 208 along respective flow paths. The divider layer 210 may generally be made of a non-porous, non-conductive and non-permeable material such as polyethylene or polypropylene. In embodiments, most of the divider layer 210 may comprise a substantially rigid structure configured to flex minimally under operating pressures. The cell 200 may also include supporting structures attached to bipolar plates 202, 206, the divider layer 210 or other structures to provide additional mechanical support to the rigid portions of the divider layer 210.

In embodiments, the divider layer 210 may include a flexible section 220 made of a lower density or more flexible material than the rigid portions of the divider layer 210. The flexible section 220 may be positioned adjacent to structures such as the bipolar plates 202, 206, the divider layer 210 or other structures within the cell configured to form the flow channels 212 and 214 to contain or otherwise direct electrolytes to and/or from the felts in the half-cell chambers 204, 208. In embodiments, the bipolar plates 202, 206 may be substantially rigid at least in a region adjacent to or coupled to the flexible section 220. The flexible section 220 and any adjacent structures may be sized and configured such that an pressure difference, such as a greater relative pressure in one half-cell flow channel 212 relative to a pressure in the second half-cell flow channel 214, may cause the flexible section 220 to deflect from the high-pressure side, such as flow channel 212 towards the low-pressure side, such as the flow channel 214. The deflection of the flexible section 220, for example, from the high pressure side to the low pressure side may cause a corresponding increase in the pressure of electrolytes flowing through the low pressure side, such as the second flow channel 214, due to the decreased cross-sectional flow area formed by the deflection of the flexible section 220 into the low pressure flow channel. In embodiments, flexible section 220 in a divider layer 210 may be provided on an inlet side, an outlet side, or both an inlet side and an outlet side of a cell 220.

### Electronic Controller Hardware

In embodiments, an electronic controller 510, as illustrated in FIG. 11, may be used to control a system 515 such as an entire RFB system, or a sub-system of the flow battery, such as a flow control sub-system. In the present example, the electronic controller 510 may be implemented with a bus architecture, represented generally by the bus 520. The bus 520 may include data lines, including bi-directional data lines, control lines, status lines, sensor lines, and other lines. The bus 520 may also include or represent one or any number of interconnecting buses, connections, channels, bridges, or other connections, depending on the specific application of the electronic controller 510 and the number of elements that may be controlled, the number of inputs that may be processed, the systems or servers to which the controller 510 may be connected, and thus, which may require interconnection and communication and/or control.

The controller 510 may include various circuits including one or more processors, represented generally by the processor 522, and computer-readable media, represented generally by the computer-readable medium 524 having instructions 542, which may include instructions for monitoring pressures or flows in the electrolyte flow channels and performing adjustments of flow meters or flow resistors to balance pressures and described herein. The processor 522 may be coupled to the computer readable medium 524 and a bus interface 526, such as through the bus 520. The processor 522 may also be linked to various other circuits, such as timing sources, peripherals, and power management circuits (not shown). The bus interface 526 may provide an interface between the bus 520 and the system 515 to be controlled 515. A user interface 540 (e.g., keypad or input device, mouse or pointing device, display, speaker, microphone, joystick) may also be provided, which may be coupled to the bus interface 526 through a line or lines 540a, which may be wired or wireless data lines, control lines, or other lines for communication between the processor 522 and the user interface 540. The processor 522 may further be coupled to an external system 500, which may include server or servers, or other system components through a line or lines 520a, which may also be wired or wireless data lines, control lines, or other lines for communication between the processor 522 and the external system 550.

The processor 522 may be configured to manage the bus 520 and general processing, including the execution of software or instructions 542 stored on the computer-readable medium 524. The instructions 542, when executed by the processor 522, may cause the processor 522 in connection with other components of the electronic controller 510 or coupled to the electronic controller 510, such as the system 515 to perform any of the various control functions described herein above for balancing pressures in the system 515. The computer-readable medium 524 may also be used for storing data that is manipulated by the processor 522 when executing the instructions 532.

In embodiments, analog electronics 534 may be coupled to the bus 520, for example, by an analog-to-digital (A/D) converter 536, which may receive analog signals from the analog electronics 534 and convert the analog signals into digital signals, which may be processed by the processor 522. The A/D converter 536 may also operate as a digital-to-analog (D/A) converter, for example, for receiving digital signals from the processor 522 over the bus 520 and generating analog control signals to be applied in system 515. Analog electronics 534 may provide analog inputs from sensors as described herein, such as pressure sensors or flow sensors, to the A/D converter 536, which may generate sensor output data values. The sensor output data values may be transferred to the processor 522 over the bus 520. The processor 522 may use the sensor output data values to perform various control actions, such as controlling flow metering devices or flow restrictors as describe herein. The processor 522 may obtain digital sensor output data values from the A/D converter 536 and may provide digital control signals to the A/D converted 536, operating as a D/A converter, which may be passed to the analog electronics 534 for application to individual flow metering devices or flow restrictor in the system 515 over a line 534a. Analog electronics 534 may further be provided to perform various analog functions such as voltage regulation, electric current measurement, current regulation or other functions. The instructions 542 on the computer readable medium 524, when read by the processor 522, may cause the processor 522 to perform operations for controlling the analog electronic components and other circuitry, including digital circuitry, connected thereto.

### Passive Flow Control Devices

In embodiments, a pressure imbalance between positive and negative electrolytes may be at least partially mitigated by increasing pressure in one flow path by substantially passive means. For example by providing narrower flow channels in the one flow path than the other. For example, if the catholyte is expected to experience a lower pressure during flow battery operation, flow channels in the positive half-cells of a flow battery cell or cell block may be made to be smaller than corresponding flow channels in the negative half-cells. Such a difference may have the effect of off-setting at least some of the expected pressure imbalance.

Alternatively, a passive flow resistor in the form of a narrow orifice, check-valve, or other reduced-cross-section flow channel portion may be provided at an outlet of a cascade or at an outlet of a single cell block in at least one electrolyte flow line (e.g., the receiving electrolyte line). When used in an RFB in which flow direction may be reversed, a passive flow restriction may include an orifice check valve which, as used herein, includes any device configured to allow free flow of fluid in one direction while restricting flow to a desired degree in the opposite direction. Orifice check valves may take many structural forms. An example orifice check valve is shown in FIG. 12.

The orifice check valve 600 of FIG. 12 may include a ball valve 602 configured to restrict fluid flowing from a first port 604, into the valve chamber 608 and towards a second port 606. A bypass orifice 610 may be provided to join the interior valve chamber 608 with the second port, thereby allowing a desired volume of fluid to bypass the valve 602 shutting off the remaining flow. In various embodiments, the orifice 610 may be sized to allow a desired flow rate based on other operating conditions. When fluid flow is reversed such that the second port 606 is the inlet port, the fluid pressure may cause the ball valve 602 to open, thereby allowing unrestricted fluid flow from the second port 606, into the valve chamber 608 and out through the first port 604. In alternative examples, the ball valve 602 may be replaced by any number of other valve structures such as poppet valves, duckbill valves, flutter valves, leaf valves or any other type of one-way check valve. Depending on the type of valve mechanism used, the bypass orifice may take many different forms. For example, the bypass orifice may include one or more structures allowing the degree of flow restriction through the bypass orifice to be variable. Such variable flow resistance structures may include passive or automatically controllable elements.

In embodiments, orifice check valves may be placed at an inlet and an outlet of an RFB cascade or a recirculating RFB stack. An inlet-side orifice check valve may be arranged to allow unrestricted flow in a forward direction (e.g., the direction which defines the inlet as an inlet), and to restrict flow to a desired degree in the reverse direction. An outlet-side orifice check valve may be arranged to restrict flow to a desired degree in the forward direction (e.g., the direction which defines the outlet as an outlet), and to allow unrestricted flow in the reverse direction. In some cases, orifice check valves may be positioned in only one of the electrolyte flow lines, for example in the receiving electrolyte flow line. In other cases, orifice check valves may be positioned in both electrolyte flow lines.

In embodiments, it may be desirable to pump both anolyte and catholyte electrolytes at the same flow rate. However, in embodiments where the same flow rate cannot be or is not required to be achieved, a pressure imbalance between anolyte and catholyte electrolytes may be mitigated by pumping the higher-pressure electrolyte through a cell block at a slower flow rate than the lower-pressure electrolyte. Stated differently, the pressure in the lower-pressure electrolyte flow channel may be increased relative to the higher-pressure electrolyte flow channel by increasing the flow rate of the lower-pressure electrolyte relative to the higher-pressure electrolyte. Thus, in some embodiments, the respective electrolyte flow rates may be controlled independently in order to substantially balance the electrolyte pressures. Such embodiments may also require an excess volume of the higher flow-rate electrolyte.

The foregoing description of the various embodiments is provided to enable any person skilled in the art to make or use the present invention. Various modifications to these embodiments may be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

What is claimed is:

1. A method of mitigating electrolyte migration in a redox flow battery system, the method comprising:
measuring a first pressure of a first electrolyte in a first flow path of a redox flow battery cell block, the first flow path having an inlet to and an outlet from the redox flow battery cell block;
measuring a second pressure of a second electrolyte in a second flow path of the redox flow battery cell block, the second flow path having an inlet to and an outlet from the redox flow battery cell block;
detecting that the first pressure is greater than the second pressure; and
operating a first device coupled to the redox flow battery cell block in the second flow path to increase the second pressure in the second flow path.

2. The method of claim 1, further comprising operating a second device coupled to the redox flow battery cell block in the first flow path to decrease the first pressure in the first flow path.

3. The method of claim 1, wherein:
the first device is a flow control device coupled to the outlet of the second flow path; and
the operating the device coupled to the redox flow battery cell block in the second flow path comprises operating the flow control device so as to restrict an outlet flow of the second electrolyte in the second flow path and thereby increase the second pressure.

4. The method of claim 1, wherein:
the first device is a flow control device coupled to the inlet of the second flow path; and
the operating the device coupled to the redox flow battery cell block in the second flow path comprises operating the flow control device so as to open an inlet flow of the second electrolyte in the second flow path and thereby increase the second pressure.

5. The method of claim 2, wherein:
the second device is a flow control device coupled to the outlet of the second flow path; and
the operating the second device coupled to the redox flow battery cell block in the first flow path comprises operating the flow control device so as to open an outlet flow of the first electrolyte in the first flow path and thereby decrease the first pressure.

6. The method of claim 2, wherein:
the second device is a flow control device coupled to the inlet of the second flow path; and
the operating the second device coupled to the redox flow battery cell block in the first flow path comprises operating the flow control device so as to restrict an inlet flow of the first electrolyte in the first flow path and thereby decrease the first pressure.

7. The method of claim 1, wherein the first device is positioned at the outlet of the second flow path.

8. The method of claim 1, wherein the first device is positioned at the inlet of the second flow path.

9. The method of claim 1, wherein the first device comprises a flow control valve.

10. The method of claim 1, wherein the first device comprises a flow control pump.

11. The method of claim 1, wherein the first device comprises a passive flow restrictor.

12. The method of claim 10, wherein the flow control pump is selected from the group consisting of: a gear pump, a screw pump, a paddle pump, a peristaltic pump, a progressive cavity pump, a piston pump, a diaphragm pump, a positive displacement flow meter, and a nutating disk flow meter.

13. The method of claim 10, wherein operating a first device coupled to the redox flow battery cell block in the second flow path to increase the second pressure in the second flow path comprises operating the flow control pump to increase a pumped flow rate of the second electrolyte in the second flow path.

14. The method of claim 1, wherein the flow control device comprises a flow resistor.

15. The method of claim 9, wherein detecting that the first pressure is greater than the second pressure comprises detecting one of the first pressure or the second pressure at a corresponding one of the outlet of the first flow path or the outlet of the second flow path.

16. The method of claim 10, wherein the flow control pump includes a flow meter at an outlet of the second flow path.

17. The method of claim 1, wherein the second electrolyte in the second flow path includes a catholyte of the redox flow battery cell block.

18. The method of claim 1, wherein the redox flow battery cell block comprises a final cell block in a plurality of cell blocks arranged in a cascade configuration along the first and the second flow paths, the redox flow battery cell block positioned adjacent to an outlet end of the cascade.

19. The method of claim 1, wherein operating a first device coupled to the redox flow battery cell block in the second flow path to increase the second pressure in the second flow path comprises operating the first device to provide a shunt resistance to a shunt current flowing in the second electrolyte in the second flow path.

20. The method of claim 19, wherein the first device includes a shunt resistor.

21. An apparatus for mitigating electrolyte migration in a redox flow battery system, comprising:
a first block of electrochemical cells and a second block of electrochemical cells arranged along a first flow channel carrying a first electrolyte and a second flow channel carrying a second electrolyte, the first block and the second block arranged along the first and the second flow channels such that the first electrolyte and the second electrolyte flow out of the first block and into the second block;
a first device positioned at an inlet side of the first block, the first device coupled to one or more of the first flow channel and the second flow channel;
a second device positioned at an outlet side of the second block, the second device coupled to one or more of the first flow channel and the second flow channel;
a controller coupled to the first device and the second device, the controller configured to control at least one of the first device and the second device to balance a first control flow parameter in the first flow channel and a second flow control parameter in the second flow channel.

22. The apparatus of claim 21, wherein the first flow control parameter is a first pressure and the second flow parameter is a second pressure.

23. The apparatus of claim 21, wherein the first flow control parameter is a first flow rate and the second flow parameter is a second flow rate.

24. The apparatus of claim 21, wherein the second block is positioned at an outlet end of a cascade of cell blocks, the second device coupled only to the outlet side of the second block.

25. The apparatus of claim 21, wherein the first block and the second block are positioned respectively at an inlet end and an outlet end of a cascade of cell blocks, the first device and the second device coupled only respectively to the inlet side of the first block and the outlet side of the second block.

26. The apparatus of claim 21, further comprising a third device positioned between the first block and the second block, the third device coupled to one or more of the first flow channel and the second flow channel.

27. The apparatus of claim 21, wherein the second device comprises a flow control device coupled to the second flow channel.

28. The apparatus of claim 21, wherein at least one of the first device or the second device is selected from the group consisting of: a valve, a ball valve, a gate valve, a globe valve, a diaphragm valve, a butterfly valve, a needle valve, a solenoid valve, an orifice check valve, a flow resistor, a pump, a gear pump, a screw pump, a paddle pump, a peristaltic pump, a progressive cavity pump, a piston pump, a diaphragm pump, a positive displacement flow meter and a nutating disk flow meter.

29. The apparatus of claim 22, further comprising a first pressure sensor coupled to the first flow channel and a second pressure sensor coupled to the second flow channel, the first pressure sensor and the second pressure sensor coupled to the controller, the first pressure sensor and the second pressure sensor configured to provide first and second pressure signals to the controller corresponding to the first pressure and the second pressure.

30. The apparatus of claim 29, wherein at least one of the first pressure sensor and the second pressure sensor is positioned at the outlet side of the second block.

31. The apparatus of claim 29, wherein the controller is further configured to determine a pressure difference between the first pressure and the second pressure based on the first pressure signal and the second pressure signal and control the operation of at least one of the first device and the second device to balance the pressure.

32. The apparatus of claim 29, wherein the controller is further configured to determine that the first pressure is greater than the second pressure based on the first pressure signal and the second pressure signal, and control the operation of the second device to increase the second pressure in the second flow channel.

33. The apparatus of claim 23, further comprising a first flow rate sensor coupled to the first flow channel and a second flow rate sensor coupled to the second flow channel, the first flow rate sensor and the second flow rate sensor coupled to the controller, the first flow rate sensor and the second flow rate sensor configured to provide first and second flow rate signals to the controller corresponding to the first flow rate and the second flow rate.

34. The apparatus of claim 29, wherein at least one of the first flow rate sensor and the second flow rate sensor is positioned at the outlet side of the second block.

35. The apparatus of claim 29, wherein the controller is further configured to determine a flow rate difference between the first flow rate and the second flow rate based on the first flow rate signal and the second flow rate signal and control the operation of at least one of the first device and the second device to balance the flow rates.

36. The apparatus of claim 29, wherein the controller is further configured to determine that the first flow rate is greater than the second flow rate based on the first flow rate signal and the second flow rate signal, and control the operation of the first device to decrease the first flow rate in the first flow channel.

37. The apparatus of claim 21, wherein the first device and the second device include a flow control device.

38. The apparatus of claim 37, wherein the first device and the second device further include shunt resistor devices.

39. The apparatus of claim 37, wherein the flow control device includes a pump selected from the group consisting of: a gear pump, a screw pump, a paddle pump, a peristaltic pump, a progressive cavity pump, a piston pump, a diaphragm pump, a positive displacement flow meter, and a nutating disk flow meter.

40. The apparatus of claim 37, wherein the flow control device comprises an electromechanically actuated valve.

41. A redox flow battery system, comprising:
a first block of electrochemical cells and a second block of electrochemical cells arranged along a first flow channel carrying a first electrolyte and a second flow channel carrying a second electrolyte, the first block and the second block arranged along the first and the second flow channels such that the first electrolyte and the second electrolyte flow out of the first block and into the second block;
a first device positioned in the first flow channel at an inlet side of the first block, the first device being configured to allow unrestricted flow in a first direction and restricted flow in an opposite second direction;
a second device positioned in the first flow channel at an outlet side of the second block, the first device being configured to allow unrestricted flow in the second direction and restricted flow in the first direction.

42. The system of claim 41, wherein the first device and the second device comprise orifice check valves.

43. A non-transitory computer readable medium comprising processor executable instructions for mitigating electrolyte migration in a redox flow battery system, the processor executable instruction, when read and executed by a processor configured to cause the processor to perform operations comprising:
measuring a first flow control parameter of a first electrolyte in a first flow path of a redox flow battery cell block, the first flow path having an inlet to and an outlet from the redox flow battery cell block;
measuring a second flow control parameter of a second electrolyte in a second flow path of the redox flow battery cell block, the second flow path having an inlet to and an outlet from the redox flow battery cell block;
detecting that the first flow control parameter is greater than the flow control parameter pressure; and
operating a first device coupled to the redox flow battery cell block in the second flow path to increase the second flow control parameter in the second flow path.

44. The non-transitory computer readable medium of claim 43, wherein the first flow control parameter includes a first pressure and the second flow parameter includes a second pressure.

45. The non-transitory computer readable medium of claim 43, wherein the first flow control parameter includes a first flow rate and the second flow control parameter includes a second flow rate.

46. The non-transitory computer readable medium of claim 44, further comprising operating a second device coupled to the redox flow battery cell block in the first flow path to decrease the first pressure in the first flow path.

47. The non-transitory computer readable medium of claim 44, wherein:
the first device is a flow control device coupled to the outlet of the second flow path; and
in causing the processor to perform the operation of operating the device coupled to the redox flow battery cell block in the second flow path, the processor executable instructions cause the processor to perform further operations comprising operating the flow control device so as to restrict an outlet flow of the second electrolyte in the second flow path and thereby increase the second pressure.

48. The non-transitory computer readable medium of claim 44, wherein:
the first device is a flow control device coupled to the inlet of the second flow path; and
in causing the processor to perform the operation of operating the device coupled to the redox flow battery cell block in the second flow path, the processor executable instructions cause the processor to perform further operations comprising operating the flow control device so as to open an inlet flow of the second electrolyte in the second flow path and thereby increase the second pressure.

49. The non-transitory computer readable medium of claim 46, wherein:
the second device is a flow control device coupled to the outlet of the second flow path; and
in causing the processor to perform the operation of operating the second device coupled to the redox flow battery cell block in the first flow path, the processor executable instructions cause the processor to perform further operations comprising operating the flow control device so as to open an outlet flow of the first electrolyte in the first flow path and thereby decrease the first pressure.

50. The non-transitory computer readable medium of claim 46, wherein:
the second device is a flow control device coupled to the inlet of the second flow path; and
in causing the processor to perform the operation of operating the second device coupled to the redox flow battery cell block in the first flow path, the processor executable instructions cause the processor to perform further operations comprising operating the flow control device so as to restrict an inlet flow of the first electrolyte in the first flow path and thereby decrease the first pressure.

51. The non-transitory computer readable medium of claim 43, wherein the first device is positioned at the outlet of the second flow path.

52. The non-transitory computer readable medium of claim 43, wherein the first device is positioned at the inlet of the second flow path.

53. The non-transitory computer readable medium of claim 44, wherein the first device comprises a flow control valve.

54. The non-transitory computer readable medium of claim 43, wherein the first device comprises a flow control pump.

55. The non-transitory computer readable medium of claim 43, wherein the first device comprises a passive flow restrictor.

56. The non-transitory computer readable medium of claim 54, wherein the flow control pump is selected from the group consisting of: a gear pump, a screw pump, a paddle pump, a peristaltic pump, a progressive cavity pump, a piston pump, a diaphragm pump, a positive displacement flow meter, and a nutating disk flow meter.

57. The non-transitory computer readable medium of claim 54, wherein in causing the processor to perform the operation of operating a first device coupled to the redox flow battery cell block in the second flow path to increase the second pressure in the second flow path, the processor executable instructions cause the processor to perform further operations comprising operating the flow control pump to increase a pumped flow rate of the second electrolyte in the second flow path.

58. The non-transitory computer readable medium of claim 43, wherein the flow control device comprises a flow resistor.

59. The non-transitory computer readable medium of claim 53, wherein in causing the processor to perform the operation of detecting that the first pressure is greater than the second pressure, the processor executable instructions cause the processor to perform further operations comprising detecting one of the first pressure or the second pressure at a corresponding one of the outlet of the first flow path or the outlet of the second flow path.

60. The non-transitory computer readable medium of claim 54, wherein the flow control pump includes a flow meter at an outlet of the second flow path.

61. The non-transitory computer readable medium of claim 54, wherein the second electrolyte in the second flow path includes a catholyte of the redox flow battery cell block.

62. The non-transitory computer readable medium of claim 43, wherein the redox flow battery cell block comprises a final cell block in a plurality of cell blocks arranged in a cascade configuration along the first and the second flow paths, the redox flow battery cell block positioned adjacent to an outlet end of the cascade.

63. The non-transitory computer readable medium of claim 43, wherein in causing the processor to perform the operation of operating a first device coupled to the redox flow battery cell block in the second flow path to increase the second flow control parameter in the second flow path, the processor executable instructions cause the processor to perform further operations comprising operating the first device to provide a shunt resistance to a shunt current flowing in the second electrolyte in the second flow path.

64. The non-transitory computer readable medium of claim 43, wherein the first device includes a shunt resistor.
